(19) United States
(12) Patent Application Publication
(10) Pub. No.: US 2023/0332926 A1
(43) Pub. Date: Oct. 19, 2023

(54) Method and Device for Compensating for Sensor Drift

(71) Applicant: UNIST (Ulsan National Institute of Science and Technology), Ulsan (KR)

(72) Inventors: Sungil Kim, Ulsan (KR); Ju Hui Lee, Ulsan (KR); Chie Hyeon Lim, Ulsan (KR); Jung Hye Lee, Ulsan (KR); Ye Jin Kim, Ulsan (KR); Ye Ram Kim, Ulsan (KR); Nam U Kim, Ulsan (KR); Se Won Kim, Ulsan (KR); Yong Kyung Oh, Ulsan (KR)

(21) Appl. No.: 18/012,626

(22) PCT Filed: Aug. 12, 2021
(86) PCT No.: PCT/KR2021/010729

§ 371 Date: Dec. 22, 2022

(30) Foreign Application Priority Data
Aug. 12, 2020 (KR) 10-2020-0101037

(51) Int. Cl. G01D 3/028; G01D 3/02; G06N 3/12

(52) U.S. Cl. CPC G01D 3/028; G01D 3/02; G06N 3/12

(57) ABSTRACT

A method and a device for compensating for sensor drift are disclosed. A method for compensating for sensor drift, according to one embodiment, comprises the steps of: confirming the suitability of sensor data; defining a transformation model for transforming the sensor data; setting a loss function on the basis of the transformation model; and optimizing the transformation model on the basis of the loss function.

### TECHNICAL FIELD

The following description relates to a method and a device for compensating for sensor drift.

The present disclosure has been implemented with the support of the Korean government (the Ministry of Science and ICT) (Assignment Unique Number: 1711152473).

### BACKGROUND ART

Sensor drift refers to the inconsistency of a sensor caused by an abnormal cause, such as contamination or aging of a material sensed by a sensor, and external environmental factors, such as temperature or humidity. Such sensor drift may prevent sensor measurement values from being classified and greatly degrade a classification accuracy, when various gases are classified according to the sensor measurement values.

Therefore, sensor drift may be a critical issue required to be addressed in order to secure the stability and reliability of a sensor system and to perform meaningful sensor data analysis.

Thus far, many methods have been proposed to alleviate the sensor drift issue, but most methods may only analyze drift patterns without a direct contribution to greater data quality. In addition, although studies on drift occurring according to time to measure a gas are being conducted actively, studies on drift caused by external environments, such as temperature and humidity, are significantly less conducted.

As a related prior art, there is Korean Patent Application Publication No. 10-2002-0000768

### DISCLOSURE OF THE INVENTION

### Technical Goals

The following embodiments may provide a technique for compensating for sensor drift by transforming sensor data.

However, the technical aspects are not limited to the aforementioned aspects, and other technical aspects may be present.

### Technical Solutions

According to an aspect, a method of compensating for sensor drift includes confirming the suitability of sensor data, defining a transformation model for transforming the sensor data, setting a loss function on the basis of the transformation model, and optimizing the transformation model on the basis of the loss function.

The confirming of the suitability may include analyzing a cause of a variation included in the sensor data.

The confirming of the suitability may include analyzing a correlation between the sensor data and an external environmental variable.

The transformation model may be a transformation model that transforms the sensor data, based on an external environmental variable and a model parameter.

The loss function may include at least one of a loss function set by reflecting prior knowledge of the sensor data and a loss function set by reflecting a difference between a plurality of measurement results.

The optimizing of the transformation model may include calculating a model parameter of the transformation model that maximizes or minimizes the loss function.

The calculating of the model parameter may include calculating the model parameter by using a genetic algorithm.

According to another aspect, a device for compensating for sensor drift includes a memory configured to include instructions and a processor configured to execute the instructions. When the instructions are executed by the processor, the processor may be configured to confirm the suitability of sensor data, define a transformation model for transforming the sensor data, set a loss function on the basis of the transformation model, and optimize the transformation model based on the loss function.

The processor may be configured to analyze a cause of a variation included in the sensor data.

The processor may be configured to analyze a correlation between the sensor data and an external environmental variable.

The transformation model may be a transformation model that transforms the sensor data, based on an external environmental variable and a model parameter.

The loss function may include at least one of a loss function set by reflecting prior knowledge of the sensor data and a loss function set by reflecting a difference between a plurality of measurement results.

The processor may be configured to calculate a model parameter of the transformation model that maximizes or minimizes the loss function.

The processor may be configured to calculate the model parameter by using a genetic algorithm.

### BRIEF DESCRIPTION OF DRAWINGS

FIG. 1 is a block diagram schematically illustrating a device for compensating for sensor drift, according to an embodiment.

FIG. 2 is a diagram illustrating sensor drift.

FIGS. 3A to 3C are graphs illustrating issues arising out of sensor drift.

FIG. 4 is a flowchart illustrating an operation of the device for compensating for sensor drift shown in FIG. 1.

FIG. 5A to 5C are graphs illustrating an example of a sensor drift compensation result through the device for compensating for sensor drift shown in FIG. 1.

### BEST MODE FOR CARRYING OUT THE INVENTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the examples with reference to the accompanying drawings, like reference numerals refer to like constituent elements and a repeated description related thereto will be omitted. In the description of the examples, a detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure.

These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The same name may be used to describe an element included in the examples described above and an element having a common function. Unless otherwise mentioned, the descriptions of the embodiments may be applicable to the following embodiments and thus, duplicated descriptions will be omitted for conciseness.

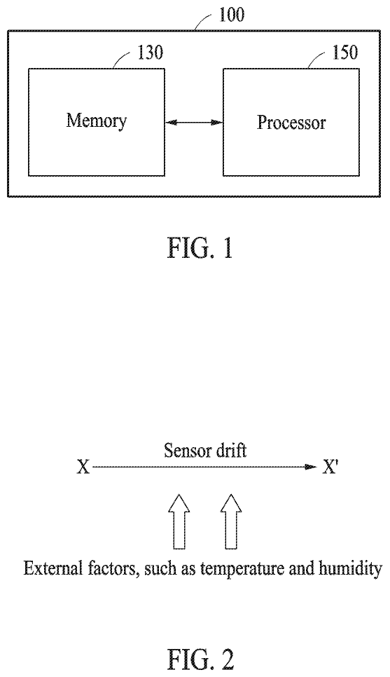

FIG. 1 is a block diagram schematically illustrating a device for compensating for sensor drift, according to an embodiment.

A device 100 for compensating for sensor drift may compensate for sensor drift occurring in a sensor. For example, the device 100 for compensating for sensor drift may compensate for sensor drift in a sensor of an electronic nose system for classifying mixed gases.

The device 100 for compensating for sensor drift may include a memory 130 and a processor 150. The processor 150 may execute computer-readable code (for example, software) stored in the memory 130 and instructions triggered by the processor 150.

The processor 150 may be a hardware-implemented data processing device having a physically structured circuit for executing desired operations. For example, the desired operations may include code or instructions in a program.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The memory 130 may store instructions (or a program) executable by the processor. For example, the instructions may include instructions to perform an operation of the processor and/or an operation of each element of the processor.

The memory 130 may be implemented as a volatile or non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque-MRAM (STT-MRAM), conductive bridging RAM (CBRAM), ferroelectric RAM (FeRAM), phase change RAM (PRAM), resistive RAM (RRAM), nanotube RRAM, polymer RAM (PoRAM), nano-floating gate memory (NFGM), holographic memory, a molecular electronic memory device, or insulator resistance change memory.

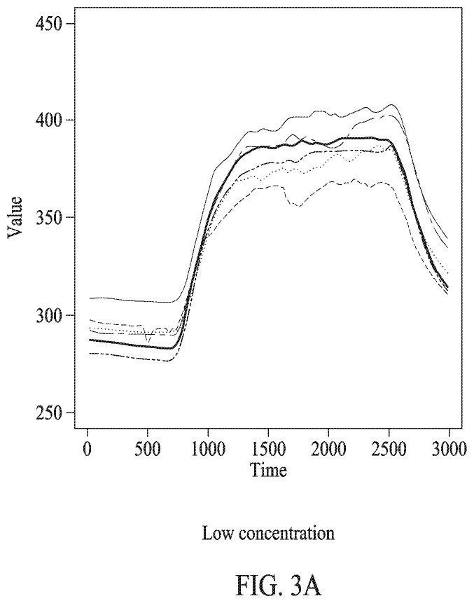

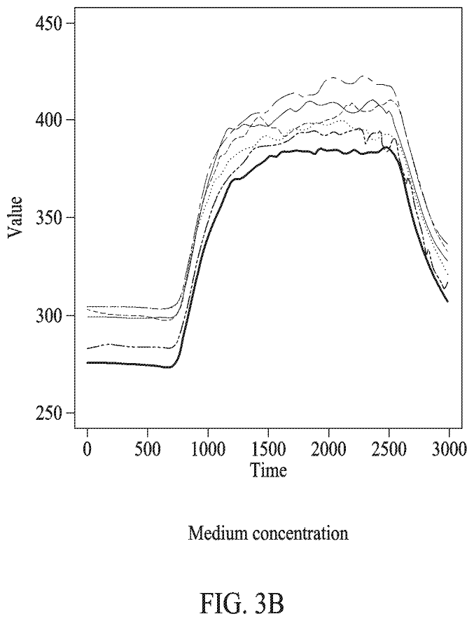

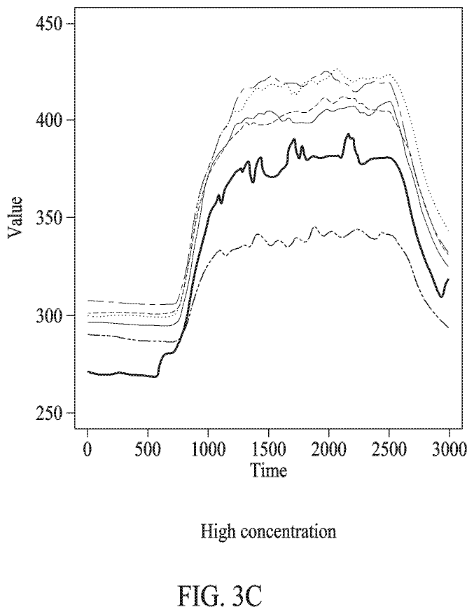

FIG. 2 is a diagram illustrating sensor drift, and FIGS. 3A to 3C are graphs illustrating issues arising from sensor drift.

An electronic nose may be a device used for detecting odors and/or smells by mimicking the human sense of smell. The electronic nose may be a system that analyzes a unique signal pattern of a specific odor, using a sensor array including different types of sensors, and may detect odors and/or smells by using an oxidation-reduction reaction of semiconductors.

Sensor drift may occur when the electronic nose measures a certain gas through a sensor. For example, there may be a variation between a value measured by the electronic nose and an ideal value to be actually measured. Such a variation may include a systematic variation caused by an abnormal cause and a variation, such as random noise, caused by an accidental cause. In general, it may be impossible or costly to reduce a variation caused by random noise, whereas a variation caused by an abnormal cause may be reduced by an engineering technique at a relatively low cost.

The sensor drift may refer to the inconsistency of a sensor caused by an abnormal cause of an external environmental factor. For example, the sensor drift may refer to a change in a sensor measurement value, which may be caused by factors, such as contamination, aging, temperature, humidity, and/or the like of a material sensed by a sensor.

When gases are classified based on sensor data of the gases measured by using an electronic nose, the sensor drift may change the sensor data, thus greatly degrading the accuracy of gas classification.

The sensor drift may need to be compensated for to ensure the stability and/or reliability of a sensor system and to obtain an analysis result of meaningful sensor data.

The device 100 for compensating for sensor drift may use external environment data to compensate for the sensor drift.

The device 100 for compensating for sensor drift may assume that an external environmental variable occupies a large proportion of abnormal causes triggering the sensor drift. That is, the device 100 for compensating for sensor drift may assume that other abnormal causes, such as contamination and/or aging of the sensor, are absent or negligible.

Actual data X may indicate ideal sensor data without variation with respect to a specific gas. Sensor data X′ may indicate sensor data with sensor drift generated by external environmental factors, such as temperature and/or humidity. That is, the sensor data X′ may be a data matrix including sensor data in which a plurality of sensors measure an object over time, and the actual data X may be a data matrix including ideal data that the sensor data X′ is supposed to have.

When a specific gas or a mixed gas is measured, the sensor may measure a change in a sensor value over time for a certain period and repeat the measurement. In this case, since the external environmental factors, such as temperature and/or humidity, may change with time, a measured value may be different every time the sensor measures the value.

FIGS. 3A to 3C may illustrate sensor data obtained by measuring two types of mixed gases. FIGS. 3A to 3C may illustrate sensor data obtained by measuring a mixed gas having a low concentration, a mixed gas having a medium concentration, and a mixed gas having a high concentration, respectively. The three pieces of sensor data may need to be clearly distinguishable from each other in an ideal case.

Although FIG. 3A to FIG. 3C are data obtained by measuring mixed gases having different concentrations, the sensor drift may occur, and accordingly, pieces of sensor data measured at concentrations, respectively, may not be distinguished from each other. That is, the three mixed gases may be hardly distinguishable from one another based on the pieces of sensor data as the mixed gases at the three concentrations show values 370 to 400 after a predetermined time.

Lines in each graph may represent results of five repeated experiments. Ideally, the five lines of each graph may need to be identical when all of external environments are the same.

A method of compensating for sensor drift in the related art may attempt to restore the actual data X from the sensor data X′, whereas the device 100 for compensating for sensor drift may use a method of transforming the sensor data X′ into transformation data X. For example, the device 100 for compensating for sensor drift may obtain the transformation data X″ that is not required to be similar to the actual data X and may obtain a desired result based on the sensor data X′.

The device 100 for compensating for sensor drift may obtain the transformation data X″ instead of attempting to restore the actual data X, based on the sensor data X′, thus achieving a desired purpose with a small number of pieces of data, and may improve a determination function based on the sensor data X′.

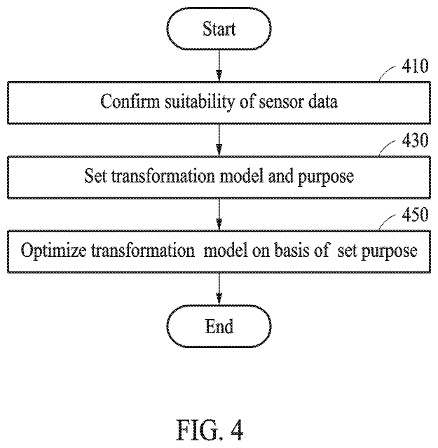

FIG. 4 is a flowchart illustrating an operation of the device for compensating for sensor drift shown in FIG. 1.

The processor 150 may confirm the suitability of sensor data before compensating for sensor drift in operation 410. For example, the processor 150 may determine whether sensor data is suitable for compensating for sensor drift.

The processor 150 may determine, through analysis of variance (ANOVA), a proportion of systematic variations, which are triggered by an abnormal cause, among the total variations included in the sensor data. For example, the processor 150 may decompose an ANOVA variation to identify a statistically meaningful impact of the systematic variations on the total variations, through hypothesis testing.

The processor 150 may determine that it is not suitable to compensate for sensor drift, when most of the variations of the sensor data are analyzed as random noise generated by an accidental cause.

The processor 150 may also determine whether a significant correlation exists between the sensor data and an external environmental variable, such as temperature and/or humidity. For example, the processor 150 may assume a specific linear model and learn the model to estimate a parameter included in the model and may confirm whether the estimated parameter is positive or negative so as to determine whether the variable has a positive correlation, a negative correlation, or no relationship, with an independent variable. The processor 150 may determine whether the estimated parameter is meaningful through the hypothesis test.

The processor 150 may determine that it is not suitable to perform sensor drift compensation on the sensor data when there is no meaningful relationship between the external environment variable and the sensor data.

The processor 150 may compensate the sensor data, which is determined to be appropriate, for sensor drift.

The processor 150 may define a transformation model fₐ(X′, Z) for transforming the sensor data and a loss function according to a set purpose in operation 430.

The transformation model fₐ(X′, Z) may be a transformation model for transforming the sensor data X′ into the transformation data X″ as shown in Equation 1. The transformation model fₐ(X′, Z) may include all models, such as a linear transformation or a nonlinear transformation.

$${X}^{′} {⟶}^{Transformation} {X}^{″} = {f}_{α} ( {X}^{′} , Z ) \qquad [ Equation 1 ]$$

Input data of the transformation model fₐ(X′, Z) may be the sensor data X′ and an external environmental variable Z for temperature and/or humidity, and the like. The transformation model fₐ(X′, Z) may transform the sensor data X′ into the transformation data X″, based on a model parameter a, and output the transformation data X″. The sensor data X′ and the external environmental variable Z may be measured values, and the processor 150 may obtain the transformation data X″ desired, through a value of the appropriate parameter α.

In operation 450, the processor 150 may optimize the transformation model fₐ(X′, Z) based on a set purpose. For example, the processor 150 may define a loss function based on the set purpose and obtain the optimal parameter α based on the loss function.

The processor 150 may define the loss function by reflecting domain knowledge. In this case, the domain knowledge may mean prior knowledge of a sensor measurement value of a specific mixed gas. For example, the processor 150 may define the loss function based on the prior knowledge that a sensor measurement value of a high concentration gas should be greater than that of a medium concentration gas and a sensor measurement value of a medium concentration gas should be greater than that of a low concentration gas, with respect to the sensor measurement values according to the concentrations.

The processor 150 may define the loss function for greater data quality. For example, since sensor measurement values, which are repeatedly measured, ideally remain the same under the assumption that external environmental conditions are the same, the processor 150 may define the loss function, so that the repeatedly measured sensor data remains the same.

The processor 150 may define each loss function for each purpose but may define one loss function by combining a plurality of purposes.

The processor 150 may optimize the transformation model fₐ(X′, Z) based on the defined loss function. For example, the processor 150 may optimize the transformation model fₐ(X′, Z) by obtaining an optimization parameter α* that minimizes the loss function. The processor 150 may obtain the optimization parameter α* as shown in Equation 2.

$${α}^{*} = {arg min}_{α} ℒ ( {f}_{α} ( {X}^{′} , Z ) \qquad [ Equation 2 ]$$

The processor 150 may estimate the optimization parameter α*, using a genetic algorithm. The genetic algorithm may be a parallel and global search algorithm and an algorithm that expresses possible solutions to an issue to be solved in a data structure of a fixed form and then produces better solutions by gradually transforming the solutions.

The processor 150 may obtain the transformation model fₐ(X′, Z), which is optimized and transforms the sensor data X′ into the transformation data X″ capable of accurately classifying measurement objects. The processor 150 may also improve a classification accuracy for other measurement objects based on the transformation model fₐ(X′, Z).

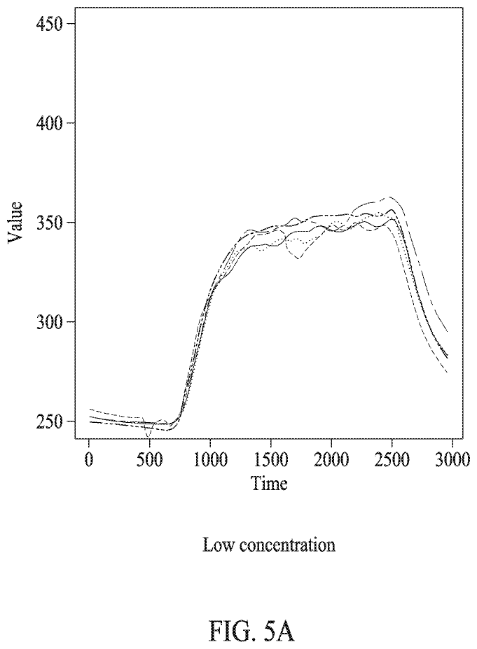

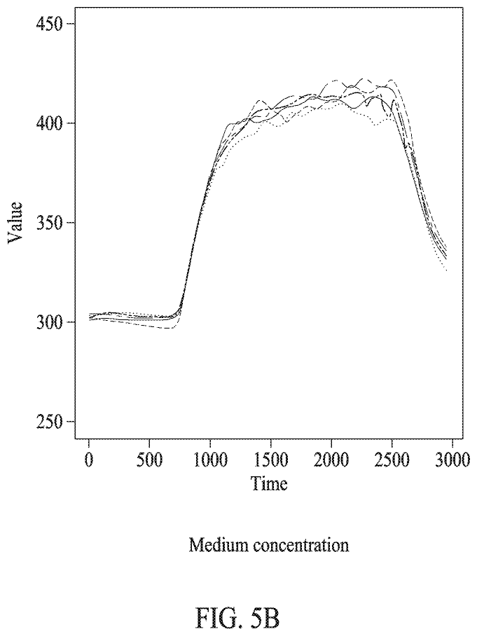

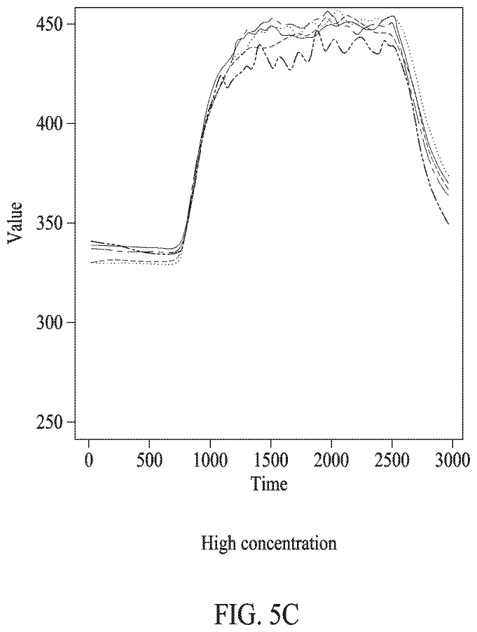

FIG. 5A to 5C are graphs illustrating an example of a sensor drift compensation result through the device for compensating for sensor drift shown in FIG. 1.

Hereinafter, an operation, in which a device 100 for compensating for sensor drift transforms sensor data shown in FIGS. 3A to 3C, using the method described above, is described in detail.

A processor 150 may define a transformation model as in Equation 3 for sensor data obtained from one sensor and, based thereon, define a transformation model as in Equation 4 for sensor data obtained from a plurality of sensors.

z₁=(α₁Tᵢ+α₂RHᵢ+α₃)y_{I}+α₄Tᵢ+α₅RHᵢ [Equation 3]

zᵢⱼ=(αⱼ₁Tᵢⱼ+αⱼ₂RHᵢⱼ+αⱼ₃)yᵢⱼ+αⱼ₄Tᵢⱼ+αⱼ₅RHᵢⱼ [Equation 4]

In Equation 3, yᵢ, zᵢTᵢ, and RHᵢ may denote a measured value, a transformed value, a temperature, and a relative humidity in an i^{th} measurement over time, respectively. αᵢ, α₂, α₃, α₄, and as may denote each element of a model parameter for a sensor. That is, the processor 150 may estimate each element α₁, α₂, α₃, α₄, and as of the model parameter for one sensor, based on a loss function.

Equation 4 may denote a transformation model for sensor data measured in the i^{th} measurement through a j^{th} sensor among the plurality of sensors. That is, in Equation 4 yᵢⱼ, zᵢⱼ, Tᵢⱼ, and RHᵢⱼ may denote a measured value, a transformed value, a temperature, and a relative humidity at the i^{th} measurement over time at the j^{th} sensor, respectively. αⱼ₁, αⱼ₂, αⱼ₃, αⱼ₄, and αⱼ₅ may denote each element of the model parameter of the j^{th} sensor. The processor 150 may estimate each element αⱼ₁, αⱼ₂, αⱼ₃, αⱼ₄, and αⱼ₅ of the model parameter for each sensor, based on the loss function.

The processor 150 may define a loss function J1 reflecting domain knowledge as in Equation 5.

J₂=(min l_{C}−max u_{B})+(min l_{B}−max u_{A})+(min l_{C}−max u_{A}) [Equation 5]

In this case, l_{A}, u_{A}, l_{B}, u_{B}, l_{C}, and u_{c} may denote the maximum and minimum values of transformed data of measured values for mixed gases with a low concentration, a medium concentration, and a high concentration, respectively.

The processor 150 may obtain an optimization parameter α of a transformation model in which a loss function J₁ may be maximized That is, the processor 150 may optimize the transformation model to transform sensor data, so that sensor data measured in a mixed gas having a medium concentration has a greater value than in a mixed gas having a low concentration and sensor data measured in a mixed gas having a high concentration has a greater value than in a mixed gas having a medium concentration.

The processor 150 may define a loss function J₂ for improving data quality as in Equation 6.

$${J}_{2} = \frac{{s}_{b}}{{2}_{w}} \qquad [ Equation 6 ]$$

Here, s_{b} and s_{w} may denote indicators of scatteredness, s_{b} may denote between-class scatter, and s_{w} may denote within-class scatter. A great s_{b} may refer to a great difference in data values between different classifications, and a great s_{w} may refer to a great difference in data values in the same classification.

s_{b} and s_{w} may be expressed as in Equations 7 and 8, respectively.

S_{w}=Σᵢ₌₁ ⁿ(xᵢ−μ_{yi}) (xᵢ−μ_{yi})^{T} [Equation 7]

S_{b}=Σₖ₌₁ⁿnₖ(μₖ−μ) (μₖ−μ)^{T} [Equation 8]

I [symbol] ed value included in a classification yᵢ, and μ_{yi} may denote an average or measured values included in the classification yᵢ. μₖ may denote an average of measured values included in a kth classification, μ may denote an average of μₖ, and nₖ may denote a weight for each classification.

In another example, s_{b} and s_{w} may be expressed as in Equations 9 and 10, respectively.

$${S}_{w} = n {\sum }_{t = 1}^{n} \frac{1}{{n}_{k}} {\sum }_{i \vert {y}_{i} = k} ( {x}_{i} - {μ}_{yi} ) {( {x}_{i} - {μ}_{yi} )}^{T} \qquad [ Equation 9 ]$$

$${S}_{b} = n {\sum }_{k = 1}^{n} ( {μ}_{k} - μ ) {( {μ}_{k} - μ )}^{T} \qquad [ Equation 10 ]$$

The processor 150 may improve a data quality by obtaining the optimization parameter a of the transformation model capable of maximizing a loss function J_{2.} That is, the processor 150 may optimize the transformation model to transform sensor data, so that repeatedly measured values of the same gas may have similar values to one another.

FIGS. 5A to 5C illustrate a result of transforming the sensor data shown in FIGS. 3A to 3C through a transformation model obtained by the processor 150. Transformed sensor data shown in FIGS. 5A to 5C may have values very similar to each other during repeated measurement and show a greatest value at a high concentration, a middle value at a medium concentration, and a smallest value at a low concentration.

The device 100 for compensating for sensor drift may improve the classification accuracy of a measurement object by setting and optimizing a transformation model for transforming sensor data.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files including higher-level code that may be executed by the computer using an interpreter. The above-described devices may be configured to act as one or more software modules in order to perform the operations of the above-described embodiments, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

1. A method of compensating for sensor drift, the method comprising the steps of:
confirming the suitability of sensor data;
defining a transformation model for transforming the sensor data;
setting a loss function on the basis of the transformation model; and
optimizing the transformation model on the basis of the loss function.

2. The method of claim 1, wherein the confirming of the suitability comprises analyzing a cause of a variation comprised in the sensor data.

3. The method of claim 1, wherein the confirming of the suitability comprises analyzing a correlation between the sensor data and an external environmental variable.

4. The method of claim 1, wherein the transformation model is a transformation model that transforms the sensor data, based on an external environmental variable and a model parameter.

5. The method of claim 1, wherein the loss function comprises at least one of a loss function set by reflecting prior knowledge of the sensor data and a loss function set by reflecting a difference between a plurality of measurement results.

6. The method of claim 1, wherein the optimizing of the transformation model comprises calculating a model parameter of the transformation model that maximizes or minimizes the loss function.

7. The method of claim 6, wherein the calculating of the model parameter comprises calculating the model parameter by using a genetic algorithm.

8. A non-transitory computer-readable storage medium storing instructions that, when executed by a processor, cause the processor to perform the method of any one of claims 1 through 7.

9. A device for compensating for sensor drift, the device comprising:
a memory configured to comprise instructions; and
a processor configured to execute the instructions,
wherein, when the instructions are executed by the processor, the processor is configured to confirm the suitability of sensor data, define a transformation model for transforming the sensor data, set a loss function on the basis of the transformation model, and optimize the transformation model based on the loss function.

10. The device of claim 9, wherein the processor is configured to analyze a cause of a variation comprised in the sensor data.

11. The device of claim 9, wherein the processor is configured to analyze a correlation between the sensor data and an external environmental variable.

12. The device of claim 9, wherein the transformation model is a transformation model that transforms the sensor data, based on an external environmental variable and a model parameter.

13. The device of claim 9, wherein the loss function comprises at least one of a loss function set by reflecting prior knowledge of the sensor data and a loss function set by reflecting a difference between a plurality of measurement results.

14. The device of claim 9, wherein the processor is configured to calculate a model parameter of the transformation model that maximizes or minimizes the loss function.

15. The device of claim 14, wherein the processor is configured to calculate the model parameter by using a genetic algorithm.
